(19) United States
(12) Patent Application Publication
(10) Pub. No.: US 2023/0015697 A1
(43) Pub. Date: Jan. 19, 2023

(54) APPLICATION PROGRAMMING INTERFACE (API) AUTHORIZATION

(71) Applicant: Citrix Systems, Inc., Fort Lauderdale, FL (US)

(72) Inventor: Subramanian Krishnan, Bangalore (IN)

(21) Appl. No.: 17/374,206

(22) Filed: Jul. 13, 2021

(51) Int. Cl. H04L 29/06; G06F 9/54

(52) U.S. Cl. CPC H04L 63/10; G06F 9/541; H04L 63/08

(57) ABSTRACT

A method may include receiving, by a first computing system, a first message indicative of a rate at which a second computing system is requesting to make application programming interface (API) calls. The method may further include based at least in part on the first message, configuring the first computing system to enable the second computing system to use an access credential to make API calls at the rate. The method may also include sending, from the first computing system to the second computing system, the access credential.

### BACKGROUND

Many software applications or websites may employ one or more application programming interfaces (APIs). An API of an application may allow outside communication with the application by systems running other applications. For example, another application or system may call the API of the application and request to obtain data, a service, or something else of value. The API may outline how other applications or systems may communicate with the API, such as the types and/or formats of calls or requests that can be made with the API. The API or a related server(s) may authenticate the other applications or systems or authorize calls or requests made by the other applications or systems.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may include receiving, by a first computing system, a first message indicative of a rate at which a second computing system is requesting to make API calls. The method may further include based at least in part on the first message, configuring the first computing system to enable the second computing system to use an access credential to make API calls at the rate. The method may also include sending, from the first computing system to the second computing system, the access credential.

In some disclosed embodiments, a first system may include at least one processor and at least one computer-readable medium encoded with instructions which, when executed by the at least one processor, cause the first system to receive a first message indicative of a rate at which a second system is requesting to make application programming interface (API) calls. The at least one computer-readable medium may be further encoded with additional instructions which, when executed by the at least one processor, cause the first system to, based at least in part on the first message, configure the first system to enable the second system to use an access credential to make API calls at the rate. The at least one computer-readable medium may also be encoded with additional instructions which, when executed by the at least one processor, cause the first system to send, to the second system, the access credential.

In some disclosed embodiments, a method may include receiving, by an agent and from a first computing system, a first message requesting approval of a rate at which a second computing system is requesting to API calls. The method may further include sending, from the agent to the first computing system, a second message approving the rate. The method may also include receiving, by the agent and from the first computing system, a third message including an authorization code, the authorization code configured to enable the second computing system to obtain, from the first computing system, an access credential to make API calls at the rate. The method may additionally include redirecting, by the agent, the third message to the second computing system.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a diagram showing example components of a first illustrative API authorization system in accordance with some aspects of the present disclosure;

FIG. 1B is a diagram showing example components of a second illustrative API authorization system in accordance with some aspects of the present disclosure;

FIG. 2 is a diagram of a network environment in which some components of API authorization systems disclosed herein may be deployed;

FIG. 3 is a diagram of an example computing system that may be used to implement one or more components of the network environment shown in FIG. 2;

FIG. 4 is a diagram of a cloud computing environment in which various aspects of the disclosure may be implemented;

FIG. 5 shows an example API authorization process involving example operations in accordance with various aspects of the disclosure;

FIG. 6 shows a sequence diagram illustrating an example workflow involving the example API authorization system shown in FIG. 1A;

FIG. 7 shows a sequence diagram illustrating an example workflow involving the example API authorization system shown in FIG. 1B; and

FIG. 8 also shows an example API authorization process involving example operations in accordance various aspects of the disclosure.

### DETAILED DESCRIPTION

For purposes of reading the description of the various embodiments below, the following descriptions of the sections of the specification and their respective contents may be helpful:

Section A provides an introduction to example embodiments of API authorization systems and processes configured in accordance with some aspects of the present disclosure;

Section B describes a network environment which may be useful for practicing embodiments described herein;

Section C describes a computing system which may be useful for practicing embodiments described herein;

Section D describes a cloud computing environment which may be useful for practicing embodiments described herein;

Section E provides a more detailed description of example embodiments of the API authorization systems and processes introduced in Section A; and

Section F describes example implementations of methods, systems/devices, and computer-readable media in accordance with the present disclosure.

### A. Introduction to Illustrative Embodiments of API Authorization Systems and Processes

The number of APIs, and web APIs in particular, is constantly increasing and thus leads to constantly increasing API traffic. Some APIs may allow for accessing powerful capabilities or important data. As discussed above, an API may outline how other applications may communicate with the API, such as the types and/or formats of calls or requests that can be made with the API. A client device or application running on the client device (the “client”) may attempt to invoke a server capability or an application running on a computing system that may include one or more servers (the “server”), such as a resource provider, using, for example, a web API of the server. The client may be attempting to receive data from the server, send data to the server, invoke an operation of the server, change data on the server, or otherwise leverage one or more capabilities of the server through the API. As such, APIs typically provide something of value (e.g., data or processing capability).

While some APIs may be open or unprotected, many APIs that are deemed to provide a valuable capability are protected by authentication and/or or authorization capabilities. Authentication may refer to verifying an identity of a caller by the server. Authorization may refer to verifying that the caller is permitted to perform certain operations via the API. For example, access credentials such as a username/password, client certificate, access token, key etc., may be required to access the desired capability by calling the API.

Once the client is authorized to access the desired operation or capability (the “resource” or “resources”), there may be a quota or limit under the authorization for how many times the client is permitted to access resources from the server. The quota or limit may prevent the client from using too many resources on the server (e.g., by calling the desired operation or capability too many times or at too high a rate), which may result in downtime for the server or may render the resources unavailable from the server. For example, a certain use case of the client, such as a busy day or week with higher than usual requests for data, may require that the client make the API call too many times or at too high a rate. A usage limit issued by the server may not be complied with by the client, and the server may thus prevent the client from accessing the resources on the server.

A quota or rate limit for accessing a resource on the server may be unilaterally issued by the server. For example, API documentation of the server may indicate that an API may be called “X” number of times in a particular time period, e.g., “100” times a minute. If the client attempts to call the API at a rate greater than “100” times a minute, the server may issue an error response and deny access to the resource. The rate limit may be implemented on the server by an API gateway or instructions in the server which may keep a rate count of how many times the client has called (e.g., in the time period) the API. Once the client has exceeded the rate limit, the server may reject API calls from the client (e.g., by issuing an error code such as hypertext transfer protocol (HTTP) status code “429”). This may indicate that the client exceeded the rate limit and the client may have to request further authorization to restart the rate count to make further API calls from the server.

This process, whereby the server unilaterally issues a rate limit under which the client can make API calls from the server, may be a static approach based on API or server documentation. Such an approach may rely on the client (or an administrator thereof) being aware of a rate limit in documentation issued by the API upon registration or authorization and adjusting the rate at which the client makes API calls to the server accordingly. In some cases, the documentation may not be updated or accurate, and even if the client attempts to operate in accordance with the documentation, the client may exceed a rate limit established by the server in a way that may be inconsistent with the documentation.

Further, such a process may be biased towards the server that provides the API or the resource provider, and the client may lack the ability to request a higher rate limit or adjust the rate limit dynamically. In other words, the resource provider may dictate the number of calls or rate limit for the client (e.g., based on the documentation). If the client needs to change the rate limit, the client may need manually to seek permission from the API provider to adjust the rate limit and perhaps to adjust the corresponding documentation accordingly. This process may not meet the needs of the client as the usage of the resource by the client may vary dynamically based on use cases for the client. This may leave client and the server in unequal bargaining positions in terms of an API call rate limit for the client. Thus, it may be desirable for the client to dynamically determine and request a rate at which the API can be called from the server by the client to avoid unilateral prevention of access to resources by the server which may, for example, damage business operations on the client side. Further, there may be a need for a solution where adherence to the rate limit does not rely on a documentation-based approach as described above, where reliance on human or user involvement to adhere to the rate limit is reduced or eliminated, and where the client and server achieve more equal bargaining positions in terms of an API call rate limit for the client.

The Open Authorization 2.0 protocol (the “OAuth 2.0 protocol”) may be used to access APIs by using client credentials to receive an access credential such as a token (e.g., a bearer token or an access token) from a server. The token may be used make an API call and access a desired resource from the server. The token may be a data fragment having enough information to identify the client making the API call and a resource that the client is trying to access from the server. The server may determine if the client can access the resource based on the token. In this way, in addition to authentication and authorization for APIs, the OAuth 2.0 protocol provides a mechanism for generating and accessing tokens for clients. The OAuth 2.0 protocol is described by “The OAuth 2.0 Authorization Framework,” Request for Comments (RFC) 6749, a product of the Internet Engineering Task Force (IETF), October 2012, the entire contents of which is incorporated herein by reference.

The OAuth 2.0 protocol may enable a third party application to obtain access to an HTTP service on behalf of a resource provider by providing an approval interaction between the resource provider and the HTTP service (e.g., via the Authorization Code Flow of the OAuth 2.0 protocol). The OAuth 2.0 protocol may also allow the third-party application to obtain access to resources from the resource provider on its own behalf (e.g., via the Client Credentials Flow of the OAuth 2.0 protocol).

For example, under the OAuth 2.0 protocol, a third party application (e.g., a client) may attempt to access a user's data (e.g., a resource) from a service (e.g., a server) on behalf of the user. The third party application may be unable to access the user's data directly from the service without permission from the user. When the user launches the third party application, the third party application may attempt to call the service through an API, may receive an unauthorized call notification, and may be redirected to an authorization endpoint (e.g., an authorization server) of the service. The user may then receive a notification from the authorization server indicating that the third party application is attempting to access the user's data from the service and may request consent from the user to access the user's data. The user may provide consent and a token may be generated for the client. The client may use the token to access the user's data from the service for the third party application. In other words, the OAuth 2.0 protocol may to allow third party applications to access data from services on behalf of users who may the actually own the data.

Using the techniques and features described in the present disclosure for API authorization, various advantages may be realized. As described above, it may be desirable for the client to dynamically determine and request a rate at which the API can be called from the server by the client. The techniques and features described herein may allow for dynamic negotiation and request of a rate at which a resource (e.g., via an API call) can be requested by a client and received from a server or service. The dynamic negotiation and request of the rate may be performed during the process of requesting and receiving authorization for accessing the API and obtaining an access credential for accessing the API (e.g., a token). As part of this process, the client may identify itself, request access to the API, and also request an intended usage pattern or intended usage requirement for the API such as a rate at which the client intends to call the API. The components and operations described herein for client authentication and authorization may, for example, be based in part on the Authorization Code Flow and/or the Client Credentials Flow as described in the OAuth 2.0 protocol.

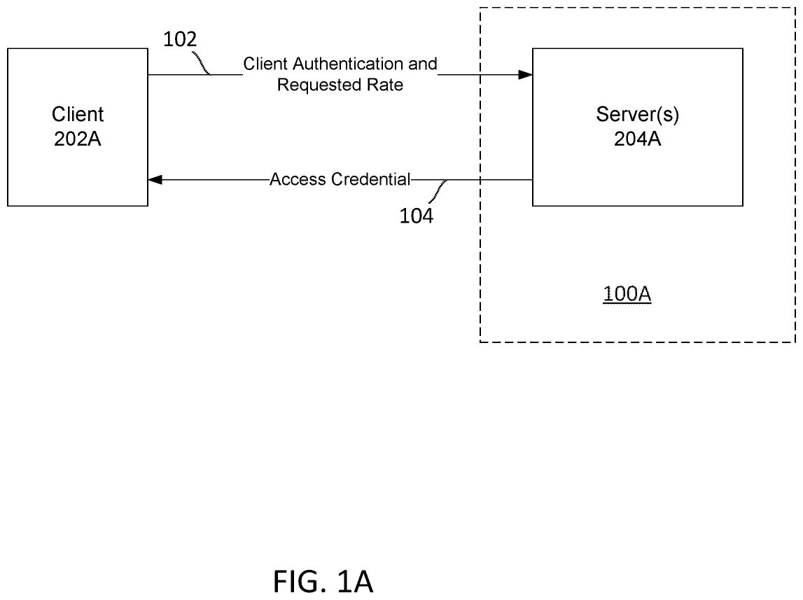

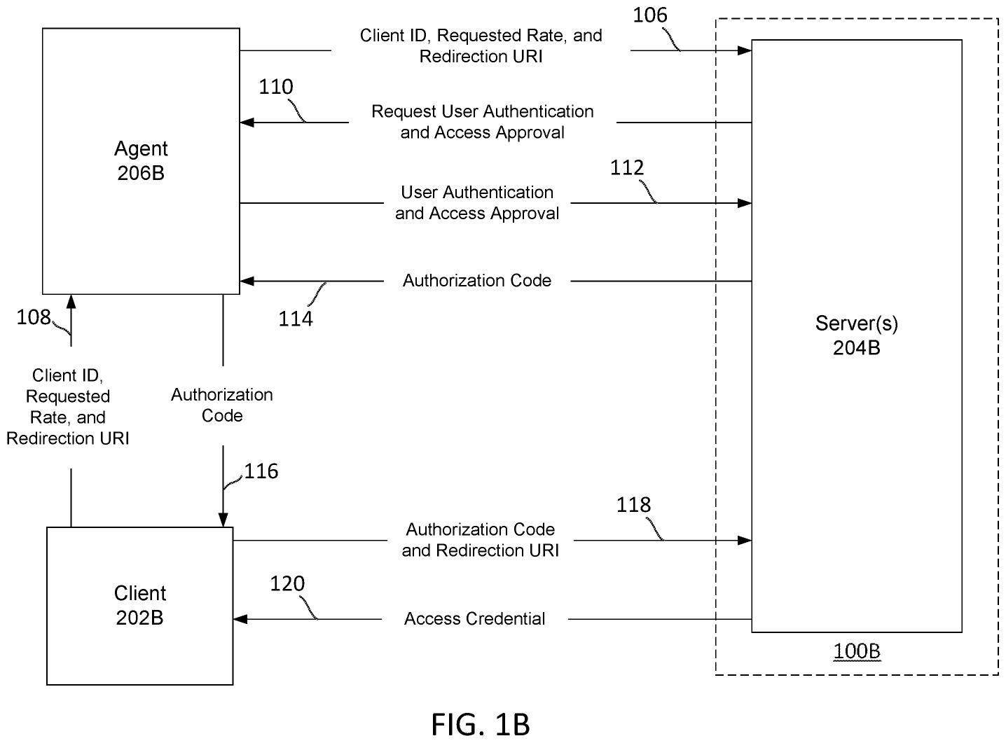

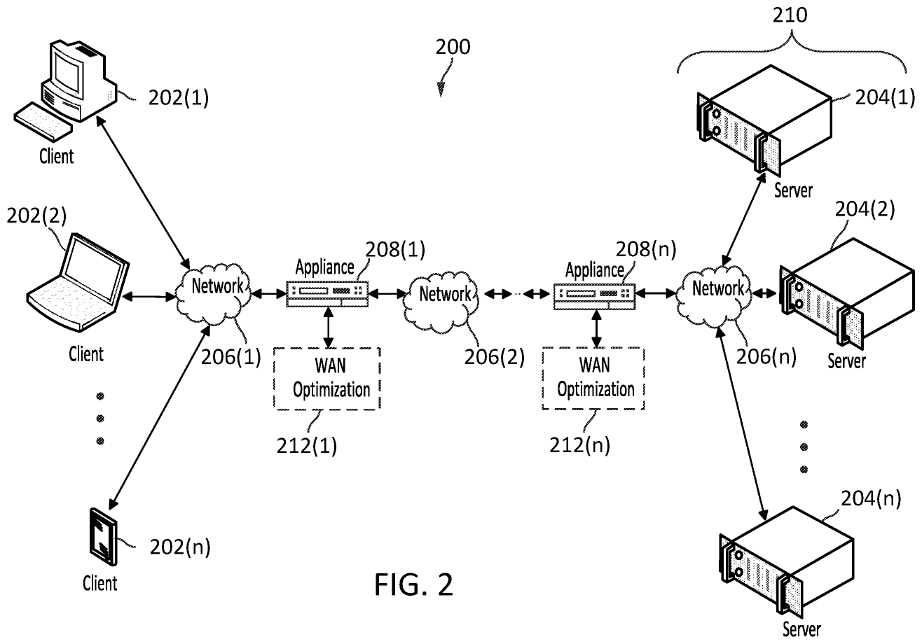

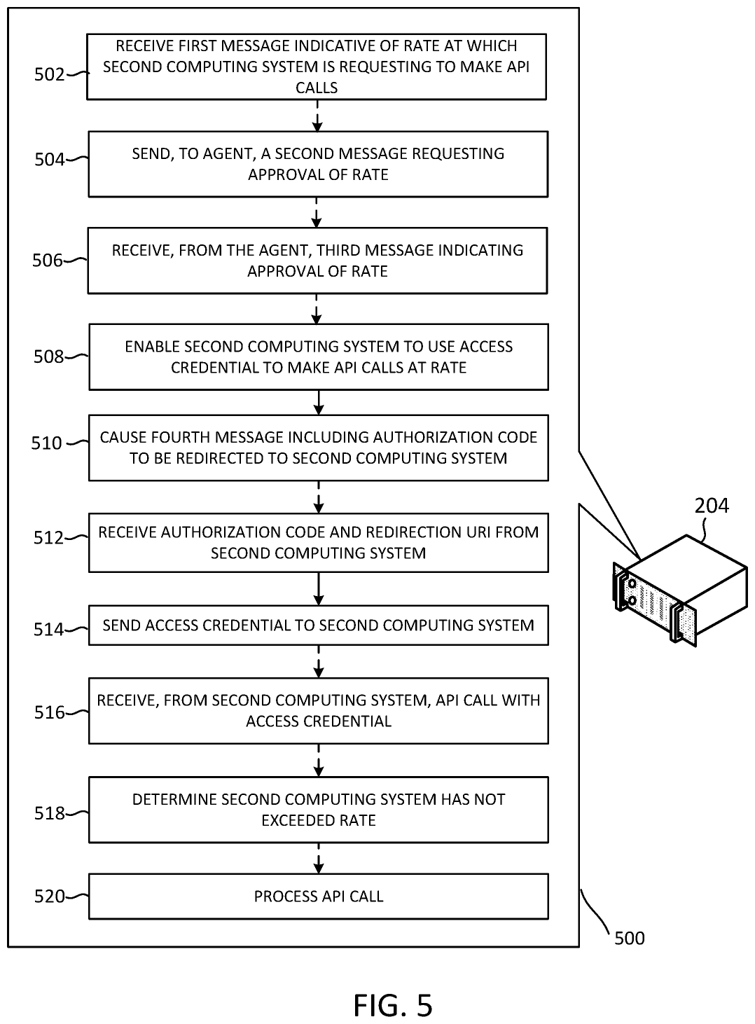

Referring now to FIG. 1A, example components of a first illustrative API authorization system 100A in accordance with aspects of the present disclosure are shown. As illustrated, the system 100A may include one or more servers 204A that may receive communications from a client 202A. Examples of client devices 202 and servers 204 that may be used to implement the client 202A and the server(s) 204A, respectively, are described below in connection with FIGS. 2-4. Referring also to FIG. 5, an example API authorization process 500 involving example operations in accordance with various aspects of the disclosure is shown. The operations shown in FIG. 5 may be performed by the system 100A of FIG. 1A. In some embodiments, one or more of the operations of the process 500 may not be performed by the system 100A or may be omitted. Further, in some embodiments, one or more of the operations of the process 500 may be performed in an order different than the order shown in FIG. 5.

As shown in FIG. 1A and FIG. 5, a first computing system (e.g., the server(s) 204A) may receive (502) from a second computing system (e.g., the client 202A) one or more first message(s) indicative of a rate at which the client 202A is requesting to make API calls. The first message(s) may, for example, correspond to an arrow 102 shown in FIG. 1A. The server(s) 204A may include an authorization server and/or may provide an authorization service on behalf of a resource provider which may provide a desired capability sought via the API call by the client 202A. The resource provider may include one or more servers that also may be included in the system 100A or may be one of the server(s) 204A. The first message(s) (e.g., as indicated by the arrow 102) may include a request by the client 202A for authentication by the server(s) 204A. Accordingly, in some implementations, the first message(s) may include both client identification information (e.g., a client identifier, login information, etc.) and a requested rate at which the client intends to call the API.

The server(s) 204A may authenticate the client 202A based on the first message(s) (e.g., the client identification information). This may be referred to as “client authentication” (e.g., authenticating the identity of the client 202A). Further, the server(s) 204A may approve the requested rate at which the client 202A intends to call the API. Approval of the rate may be based on several factors including, but not limited to, whether the resource provider has the processing capability, bandwidth, etc., to handle API calls from the client 202A at the rate requested. The server(s) 204A may determine to configure operations to enable the client 202A to use an access credential, based on authentication of the identity of the client 202A.

The server(s) 204A may also take steps to enable (508) the client 202A to use the access credential to make API calls at the rate requested. Enabling the client 202A to use the access credential to make API calls at the rate requested may be based on the first message (e.g., the rate requested via the first message(s)). Further, the server(s) 204A may send (512) the access credential to the client 202A, e.g., as indicated by an arrow 104 in FIG. 1A. The access credential may be a data fragment that includes data sufficient to allow the server(s) 204A to process API calls on behalf of the client 202A. The access credential may, for example, be a token, such as an access token or bearer token.

The system 100A and the process 500 for API authorization may be used in machine to machine interactions where there may be no user involvement. For example, as will be discussed in greater detail below, the client 202A may negotiate a rate (at which the client 202A intends to call the API) with the resource provider (e.g., via the server(s) 204A) without user involvement. In this way, API authorization with rate negotiation may be performed as a fully automated process.

Once the client 202A is authenticated and authorized (including authorization of the rate requested or otherwise negotiated, which may be referred to as the “approved rate”) by server(s) 204A, the server(s) 204A may receive (514) an API call with the access credential (e.g., the token) from the client 202A. The server(s) 204A may determine (516) that the second client 202A has not exceeded the approved rate for API calls. Based on determining (516) that the client 202A has not exceeded the approved rate for API calls, the server(s) 204A may process (518) (e.g., by the resource provider) the API call received from the client 202A.

Referring now to FIG. 1B, example components of a second illustrative API authorization system 100B in accordance with aspects of the present disclosure are shown. As illustrated, the system 100B may include one or more server(s) 204B that may receive communications from a client 202B. Examples of client devices 202 and servers 204 that may be used to implement the client 202B and the server(s) 204B, respectively, are described below in connection with FIGS. 2-4. The operations shown in FIG. 5 may be performed by the system 100B of FIG. 1B. In some embodiments, one or more of the operations of the process 500 may not be performed by the system 100B or may be omitted. Further, in some embodiments, one or more of the operations of the process 500 may be performed in an order different than the order shown in FIG. 5.

As shown in FIG. 1B and FIG. 5, a first computing system (e.g., the server(s) 204B) may receive (502) from a second computing system (e.g., the client 202B) one or more first messages (e.g., via agent 206B) indicative of a rate at which the client 202B is requesting to make API calls. The first message(s) may, for example, correspond to an arrow 106 shown in FIG. 1i. The server(s) 204B may include an authorization server and/or may provide an authorization service on behalf of a resource provider, which may provide a desired capability sought via the API call by the client 202B. The resource provider may include one or more servers that also may be included in the system 100B or may be one of the server(s) 204B. The first message(s) (e.g., as indicated by the arrow 106) may include a request by the client 202B for authentication by the server(s) 204B. This may be referred to as “client authentication.” As shown, in some implementations, the first message(s) may include client identification information (e.g., a client identifier, login information, etc.), a requested rate at which the client seeks to call the API, and a redirection uniform resource identifier (URI). The server(s) 204B may have received the first message(s) from the agent 206B (e.g., a user agent). As indicated by an arrow 108 in FIG. 1B, the agent 206B may have received the first message(s) from the client 202n, together with an instruction to redirect the first message(s) to the server(s) 204B. The agent 206n, which may include a web browser, may thus have redirected the first message(s) received from the client 202B to the server(s) 204B.

Further, after receiving the first message(s), the server(s) 204B may send (504) one or more second messages to the agent 206B requesting approval (e.g., user approval) of the access sought by the client 202B (e.g., the resource requested via the API) and/or the rate requested. The second message(s) may, for example, correspond to an arrow 110 shown in FIG. 1. As noted above, in some embodiments, the agent 206B may include a web browser. The web browser may allow a user to approve or deny the access sought by the client 202B (e.g., the resource requested via the API) and/or the rate requested. The user may approve the access and the rate via the agent 206B and/or an associated web browser, and one or more third messages may be sent from the agent 206B to the server(s) 204B indicating the user authentication and the approval of the requested rate. The third message(s) may, for example, correspond to an arrow 112 shown in FIG. 1i. The server(s) 204B may receive (506) the third message(s) from the agent 206B indicating the user authentication and the approval of the requested rate.

Additionally, the server(s) 204B may take steps to enable (508) the client 202B to use an access credential (e.g., a token) to make API calls at the rate requested. Enabling the client 202B to use the access credential to make API calls at the rate requested may be based on the first message(s) (e.g., the rate requested via the first message(s)). The server(s) 204B may also cause (510) a fourth messages including an authorization code to be redirected to the client 202B. The fourth message may, for example, correspond to an arrow 114 shown in FIG. 1B. For example, the server(s) 204B may send the fourth message and an instruction to the agent 206B. The instruction may be for the agent 206B to redirect the fourth message, including the authorization code, to the client 202B, e.g., as indicated by an arrow 116 in FIG. 1B, based on the redirection URI that was included in the first message. The authorization code may enable the client 202B to obtain the access credential.

As indicated by an arrow 118 in FIG. 1B, the client 202B may send the authorization code to the server(s) 204B and may also send the redirection URI to the server(s) 204B. In some embodiments, the client 202B may send the authorization code to a token server or token service of the resource provider (e.g., one or more of the server(s) 204B). In any event, as indicated in FIG. 5, the server(s) 204B may receive (512) the authorization code and redirection URI from the client 202B. The server(s) 204B may validate the authorization code and, as indicated by an arrow 120 in FIG. 1B, may send (514) the access credential (e.g., the token) to the client 202B.

The client 202B may receive the access credential and may use the access credential to make an API call. The server(s) 204B may receive (516) an API call with the access credential (e.g., the token) from the client 202B. The server(s) 204B may determine (518) that the server(s) 204B has not exceeded the approved rate for API calls. Based on determining (518) that the client 202B has not exceeded the approved rate for API calls, the server(s) 204B may process (520) (e.g., by the resource provider) the API call received from the client 202B.

In this regard, the inventors have recognized and appreciated that a typical process, whereby the server unilaterally issues a quota or rate limit under which the client can make API calls to the server, is generally a static approach based on API or server documentation. Further, the inventors have recognized and appreciated that this approach lacks the flexibility desired for smooth running of business operations and seamless access to APIs or server resources by the client. Additionally, the inventors have recognized and appreciated that by enabling the client to dynamically request a rate limit and/or negotiate a rate limit for accessing resources or making API calls to the server via the authentication process as described herein, a dynamic and more even-handed approach for establishing the rate limit may be realized and more predictable access to APIs for smoother business operations and less downtime may be achieved for both the client and the server.

Additional details and example implementations of embodiments of the present disclosure are set forth below in Section E, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

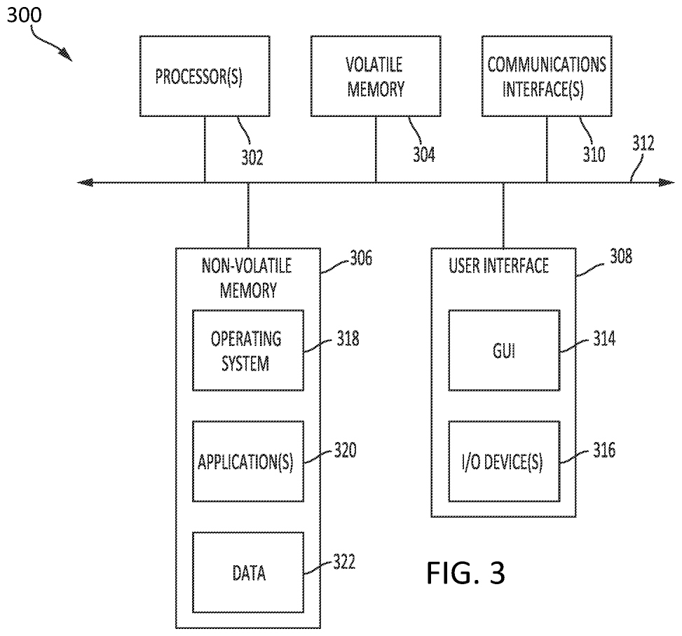

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Cloud Computing Environment

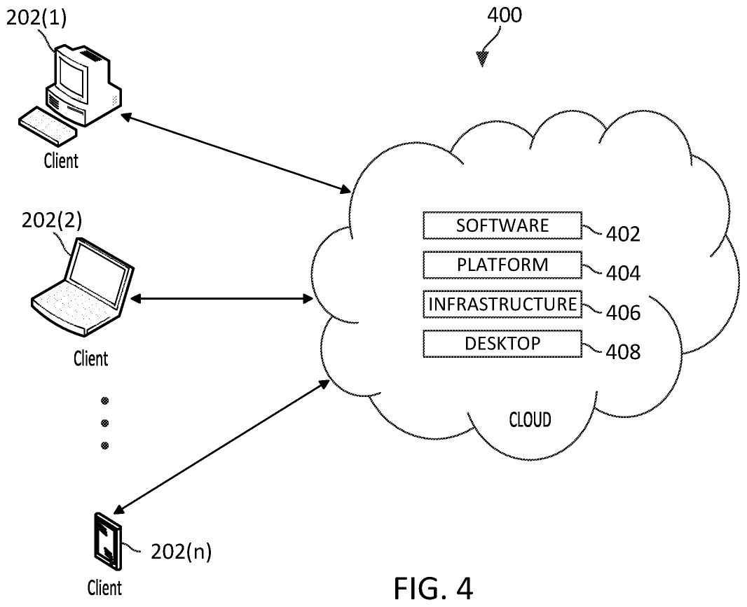

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Detailed Description of Example Embodiments of API Authorization Systems and Processes

As discussed above in Section A, API authorization systems in accordance with the present disclosure may provide several advantages. The techniques and features of the present disclosure will be described below in the context of a client seeking authentication and authorization for making API calls to a server with a requested and/or negotiated rate limit. As described in connection with FIGS. 1A, 1i, and 5, for example, the client 202A, 202B may request and/or negotiate an API rate limit for making calls to, and accessing resources from, the server 204A, 204B as part of an authentication process.

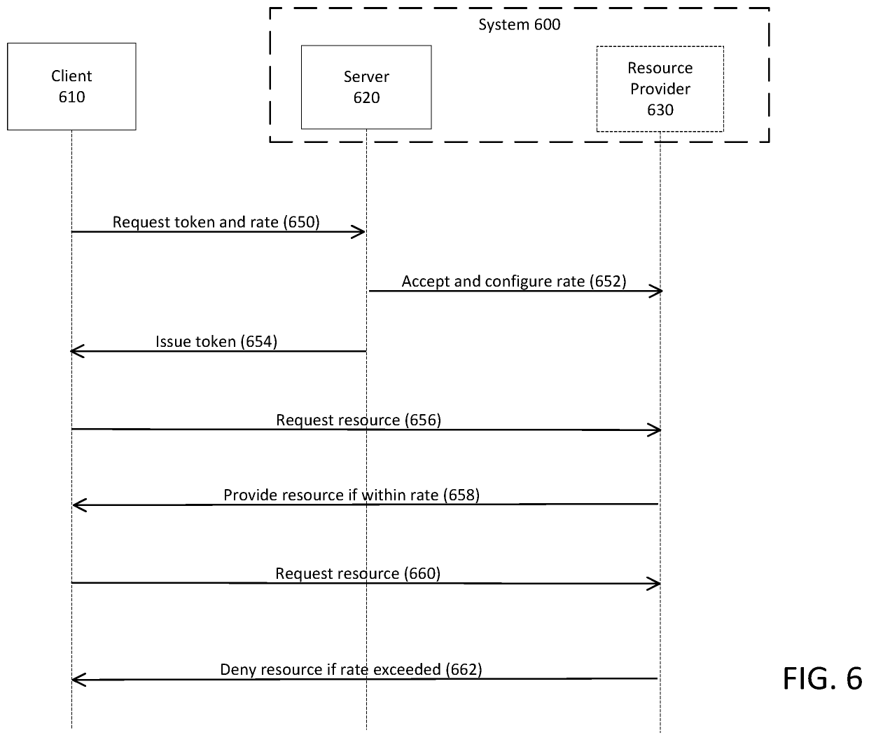

Referring now to FIG. 6, a sequence diagram illustrating an example workflow involving the example API authorization system 100A shown in FIG. 1A is shown. The example workflow may be based at least in part on the Client Credentials Flow of the OAuth 2.0 protocol. The sequence diagram shows a system 600, a client 610, a server 620, and a resource provider 630. The system 600, the client 610, and the server 620 of FIG. 6 may be similar to the system 100A, the client 202A, and the server(s) 204A of FIG. 1A, respectively. The example workflow may be part of an authentication and/or authorization process for accessing resources from the server 620 as described herein. In some embodiments, the components of the system 600 may be controlled and/or administered by the resource provider 630.

As shown in the sequence diagram, the example workflow may begin with the client 610 requesting (650) a token and a rate from the server 620. The server 620 may be an authorization server and the token may be an access credential (e.g., a data fragment as described above). The rate requested may be a rate at which (if approved) an API can be called from the resource provider 630 by the client 610. The request from the client 610 to the server 620 may also include a unit of time for a denominator (e.g., one minute) of the rate (which may be applied to API calls requested by the client 610 and which may be referred to as the rate period). For example, the client 610 may request to make “10,000” API calls per minute from the resource provider 630. The request from the client 610 to the server 620 may also include a requested scope for which the rate will be applied to API calls requested by the client 610. For example, the client 610 may request a user-level scope, an application-level scope, and/or a token-level scope for which the rate will be applied. The user-level scope for the rate may allow the client 610 to make, for example, “10,000” API calls per minute from the resource provider 630 for each user of an application for which the client 610 has requested the rate. The application-level scope for the rate may allow the client 610 to make, for example, “10,000” API calls per minute from the resource provider 630 for the entire application (e.g., across all users) for which the client 610 has requested the rate (instead of “10,000” API calls per minute for each user of the application). The token-level scope for the rate may allow the client 610 to make, for example, “10,000” API calls from the resource provider 630 with a token issued to the client 610 (e.g., until the token expires).

Further, the server 620 may accept and configure (652) the rate requested from the client 610 with the resource provider 630. The server 620 may perform operations or cause operations to be performed with the resource provider 630 (which may include one or more servers that provide the resources that will be requested by the client 610 via API calls) to enable the resource provider 630 to handle API calls at the rate, period, and/or scope requested by the client 610. For example, the server 620 may be a token server or may include a token service which may call a configuration API on the resource provider 630 or on an API Gateway that may protect the resource provider 630. In some embodiments, the token service may issue a configuration event which may be subscribed to by the resource provider 630 or the API Gateway.

The server 620 may alternatively deny the rate, period, and/or scope requested by the client 610. For example, the server 620 may deny the requested rate of “10,000” API calls per minute (e.g., with user-level or app-level scope) by the client 610 and may send a message to the client 610 to change the rate requested to “5,000” API calls per minute, or to make another request with a different or lower rate. The client 610 may accept the rate of “5,000” API calls per minute or may request a different rate (e.g., “7,500” API calls per minute), which the server 620 may either accept or deny. In this way, the client 610 and the server 620 may dynamically negotiate the rate at which API calls may be made by the client 610 to the resource provider 630 through an automated process.

Once the rate has been accepted and the resource provider 630 has been configured to handle API calls from client 610 at the requested rate, the server 620 may issue (654) a token to the client 610. The token may include information sufficient to indicate to the resource provider 630 that the client 610 is authorized to make API calls to the resource provider 630 at the accepted rate. The client 610 may use the token to request (656) a resource (e.g., via an API call) from the resource provider 630. The resource provider may process the request (e.g., via an API server) and provide (658) the resource if the request is within the approved rate. The client 610 may use the token to again request the resource (660) (e.g., via an API call) from the resource provider 630. The resource provider may process the request (e.g., via the API server) and deny (662) the resource if the request has exceeded the approved rate.

In some implementations, the client 610 may request a rate for “X” number of API calls per “Y” minutes and the client 610 may have negotiated (e.g., as described above) with the server 620 for that rate to be approved. Thus, if the client 610 exhausts the number of API calls allowed under the approved rate and is denied an API call, a new rate may need to be requested or the client 610 may need to request that the rate count be reset. This may provide a benefit over existing authorization processes as the server 620 or the resource provider 630 may retain control in this regard under the existing authorization processes without a path for the client 610 to negotiate the rate at which API calls can be made.

Further, in some embodiments, the client 610 may be coded with instructions or ranges under which to negotiate rates for making API calls with an authorization server (e.g., the server 620). For example, if an initial rate request is denied by the server 620, the client 610 may be configured to increase or decrease the rate requested until a configured threshold is reached. For example, if the rate requested is denied, the client 610 may be configured to increase or decrease the rate requested by 10%, 25%, etc., until the configured threshold is reached.

The rate requested or desired may be determined based on various use cases for the client 610. In some embodiments, a tradeoff may be involved where, for example, while configuring an application, there may be more API calls made for updated data for the benefit of consumers of the application. Additionally or alternatively, the number of API calls may be optimized and/or minimized based on how often the data needs to be updated to allow the application to be effectively used by consumers. The tradeoff may be balanced based on user experience and end user functionality. Thus, it may be desirable to change the range limit dynamically based on a certain time of the day, week, or year. For example during a busy period, the client 610 may request a higher rate limit for making API calls.

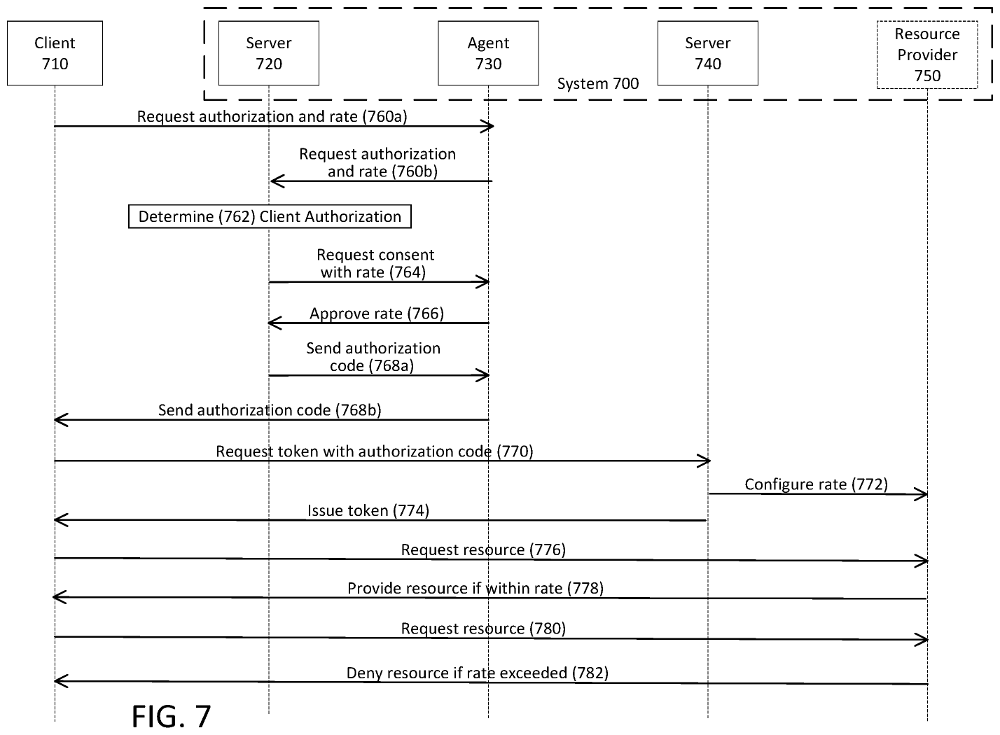

Referring now to FIG. 7, a sequence diagram illustrating an example workflow involving the example API authorization system 100B shown in FIG. 1B is shown. The example workflow may be based at least in part on the Authorization Code Flow of the OAuth 2.0 protocol. The sequence diagram shows a system 700, a client 710, a server 720, an agent 730, a server 740, and a resource provider 750. The system 700, the client 710, the server 720, and the agent 730 may be similar to the system 100B, the client 202B, the server(s) 204(B), and the agent 206B of FIG. 1B, respectively. The server 740 may be a token server or provide a token service. The resource provider 750 may be similar to the resource provider 630 of FIG. 6. In some embodiments, the components of the system 700 may be controlled and/or administered by the resource provider 750.

As shown in the sequence diagram, the example workflow may begin with the client 710 requesting (760a, 760b), via the agent 730, authorization and a rate from a server 720. The server 720 may be an authorization server and the rate may be a rate at which an API can be called from the resource provider 750 by the client 710. The request from the client 710 to the server 720, via the agent 730, may also include a requested unit of time for a denominator (e.g., one minute) of the rate (which may be applied to API calls requested by the client 710 and which may be referred to as the rate period). For example, the client 710 may request to make “10,000” API calls per minute from the resource provider 750. The request from the client 710 to the server 720 may also include a requested scope (e.g., the rate scope). For example, the client 710 may request a user-level scope, an application-level scope, and/or a token-level scope for which the rate will be applied. The user-level scope for the rate may allow the client 710 to make, for example, “10,000” API calls per minute from the resource provider 750 for each user of an application for which the client 710 has requested the rate. The application-level scope for the rate may allow the client 710 to make, for example, “10,000” API calls per minute from the resource provider 750 for the entire application (e.g., across all users) for which the client 710 has requested the rate (instead of “10,000” API calls per minute for each user of the application). The token-level scope for the rate may allow the client 710 to make, for example, “10,000” API calls from the resource provider 750 with a token issued to the client 710 (e.g., until the token expires).

Upon receiving the access request from the client 710, the server 720 may determine (762) whether, subject to approval (e.g., user approval via the agent 730, as described below), the client 710 is to be authorized to make API calls to the resource provider 750 at the requested rate and/or scope. Whether the client 710 is to be authorized to make API calls to the resource provider 750 at the requested rate and/or scope may be based on several factors including, but not limited to, whether the resource provider 750 has the processing capability, bandwidth, etc., to handle API calls from the client 710 at the rate requested and/or a subscription tier for the API that may be designated for the client 710 or obtained by the client 710. For example, the processing capability may be based on a capacity to handle API calls provisioned by the resource provider 750, historical data indicating a number of API calls typically handled by the resource provider 750 (e.g., for a time of day, day, month, etc.), and/or projections indicating an expected number of API calls that will be handled by the resource provider 750 (e.g., for a time of day, day, month, etc.). Further, the subscription tier of the client 710 may indicate a free usage limit, which may result in a lower rate for API calls authorized for the client 710, as compared to a paid-for limit or enterprise limit, either of which may result in a higher rate for API calls authorized for the client 710.

In some embodiments, determining whether the client 710 is to be authorized to make API calls to the resource provider 750 at the requested rate and/or scope may be based on one or more operational metrics. The one or more operational metrics may be determined based on total or available processing capability or capacity, memory, and/or bandwidth of the resource provider 750, the historical data indicating the number of API calls typically handled by the resource provider 750 (e.g., for a time of day, day, month, etc.), the projections indicating the expected number of API calls that will be handled by the resource provider 750 (e.g., for a time of day, day, month, etc.), and/or the subscription tier of the client 710.

The server 720 may communicate with the resource provider 750 to determine whether the client 710 is to be authorized to make API calls to the resource provider 750 at the requested rate and/or scope. For example, the server 720 may call an API available from the resource provider 750 to make the determination (e.g., based on the factors described above). In some embodiments, the server 720 may delay making the determination and return a provisional authorization code to the client 710 (e.g., via the agent 730). The client 710 may attempt to use the provisional authorization code to request a token from the server 740 and the server 740 may request that the resource provider 750 configure the requested rate. The resource provider 750 may determine (e.g., based on the factors described above) that the requested rate is acceptable and may configure the requested rate. Alternatively, the resource provider 750 may determine (e.g., based on the factors described above) that the requested rate is not acceptable and may return an error and a message indicating why the requested rate is not acceptable to the client 710 (e.g., a token is not returned to the client 710 by the server 740).

If the server 720 determines (762) to approve the request, the server 720 may send (764), to the agent 730, a request for the user to consent to the client 710 accessing the desired resources (via, e.g., an API call) from the resource provider 750 at the rate requested. The agent 730 may, for example, generate and display a consent screen (e.g., via a web browser) to a user based on the request. The user may approve or deny the request For example, the user may, via the agent 730, approve (766) and thus consent to the client 710 accessing the desired resources (via, e.g., an API call) from the resource provider 750 at the rate requested. The server 720 may receive the approval from the agent 730 and may generate an authorization code based on the approval. The server 720 may also send (768a, 768b), via the agent 730, the authorization code to the client 710. As discussed in more detail below, the client 710 may thereafter use the received authorization code to obtain a token that allows the client 710 to make API calls in compliance with the requested rate and/or scope.

The user may alternatively deny (e.g., via the agent 730) the access request by the client 710. For example, the user may indicate the denial via the consent screen and the agent 730 may indicate the denial to both the client 710 and the server 720.

If the server 720 determines to deny the request as presented, it may take any of a number of actions. For example, the server 720 may decline to authorize the request and may return an error message to the client 710 (e.g., via the agent 730). In some implementations, the error message may indicate a rate that may be acceptable (e.g., a maximum rate that is likely to be authorized). For example, the server 720 may determine a different rate and/or scope that would be acceptable for the resource provider 750, and may propose that different rate to the client 710 and/or the user (via the agent 130). The server 720 may, for instance, propose a rate of “5,000” API calls per minute (or a different rate), rather than the “10,000” API calls per minute requested by the client 710. In such a case, the server 720 may send (764) a message to the agent 730 requesting the user to consent to the client 710 accessing the desired resources (via, e.g., an API call) from the resource provider 750 at the different rate.

As discussed above, approval or denial of the rate by the server 720 may be based on several factors including, but not limited to, current resource availability of the resource provider 750 to handle API calls from the client 710 at the rate requested. For example, approval or denial of the rate by the server 720 may be based on several factors including, but not limited to, whether the resource provider has enough processing capability, bandwidth, etc., available to handle API calls from the client 710 at the rate requested. In some embodiments, the resource provider 750 may have a setting or threshold (e.g., set by an administrator or set in an automated manner) indicating how many API calls the resource provider 750 can handle per second, minute, hour, etc. The setting or threshold may be made available or indicated to the server 720. In some embodiments the setting or threshold may be set on a per client basis. In some embodiments, the setting or threshold may be a global setting or threshold for clients attempting to make API calls to the resource provider. In some embodiments, the available rate which the server 720 and/or the resource provider 750 may approve for the client 710 may be based on an algorithm that determines the available rate based on processing availability, memory availability, bandwidth availability, etc., of the resource provider 750. Whether the server 720 approves, denies, or proposes a different rate (including how the different rate may be determined) to the client 710 may be based on the setting, threshold, algorithm, or other calculation performed by the server 720 and/or the resource provider 750.

If the user approves such request (per the step 764), the server 720 may (as discussed above) generate and send (768a, 768b), via the agent 730, an authorization code to the client 710. As explained in more detail below, the client 710 may thereafter use that authorization code to obtain a token that permits the client 710 to make API calls to the resource provider 750. In in this case, however, the received token would allow the client 710 to make API calls in compliance with the different rate and/or scope determined by the server 720, rather than the originally requested rate and/or scope.

Alternatively, although not illustrated in FIG. 7, the server 720 may send, via the agent 730, a message to the client 710 proposing a different rate or scope. If the client 710 determines the different rate and/or scope is acceptable, the client 710 may send another first message (e.g., per the steps 760a and 760b) to the server 720, via the agent 730, requesting that new rate and/or scope. Or, if the client 710 determines that the different rate and/or scope is not acceptable, it may request, via the agent 730, another different rate and/or scope (e.g. 7,500 API calls per minute), by sending another first message (e.g., per the steps 760a and 760b) to the server 720, via the agent 730, requesting that other new rate and/or scope. In this way, the client 710 and the server 720 may dynamically negotiate (via the agent 730) the rate and/or scope of API calls the client 710 is permitted to make to the resource provider 750.

As noted above, upon receipt of the authorization code (per the step 768b), the client 710 may use the authorization code to request (770) a token from the server 740. The server 740 may, for example, be a token server. The token server may be configured to issue tokens to clients such that the clients may access resources from the resource provider 750. Further, the token server may configure or cause the resource provider 750 to be configured to handle API calls at the rate and/or of the scope approved by the server 720. In some embodiments, the server 720 (e.g., the authorization server) and the server 740 (e.g., the token server) may be the same server and may provide both authorization services and token services.

The server 740 may receive the request for the token (with the authorization code) from the client 710, process the request, and generate the token. Further, as discussed above, the server 740 may configure (772) or cause the resource provider to be configured to handle API calls at the rate and/or of the scope approved by the server 720. In other words, the server 740 may perform operations, or cause operations to be performed, on the resource provider 750 (which may include one or more servers that provide the resources that can be requested by the client 710 via an API call) to enable the resource provider 750 to handle API calls at the rate, period, and/or scope requested by the client 710. The server 740 may also issue (774) the token to the client 710. The token may include information sufficient to indicate to the resource provider 750 that the client 710 is authorized to make API calls to the resource provider 750 at the approved rate and/or scope.

In some embodiments, the token server (e.g., the server 740) may configure a rate-limit policy on the resource provider 750 to match the requested and approved rate. For example, the token server may call a configuration API on the resource provider 750 or an API Gateway protecting the resource provider 750. In some embodiments, the token server may issue a configuration event which may be subscribed to by the resource provider 750 or the API Gateway. In some embodiments, a negotiated rate limit event may initiate automatic provisioning (or de-provisioning) of resources (e.g., processing capacity, network bandwidth, memory, etc.) needed to handle API calls at the negotiated rate on the resource provider 630 or 750 (e.g., one or more servers).

The client 710 may use the token to request (776) a resource (e.g., via an API call) from the resource provider 750. The resource provider 750 may process the request (e.g., via an API server) and provide (778) the resource if the request is within the approved rate and/or scope. The client 710 may use the token to again request (780) the resource (e.g., via an API call) from the resource provider 750. The resource provider may process the request (e.g., via the API server) and deny (782) the resource if the request has exceeded the approved rate and/or scope.

In some embodiments, the example workflow may begin with the client 710 attempting to access the resource from the resource provider 750 (e.g., via an API call). The client 710 may receive a HTTP status code “401” which may indicate that the client 710 lacks a valid authentication credential for the resource provider 750 and the example workflow (e.g., the authorization and rate negotiation flow) may be initiated.

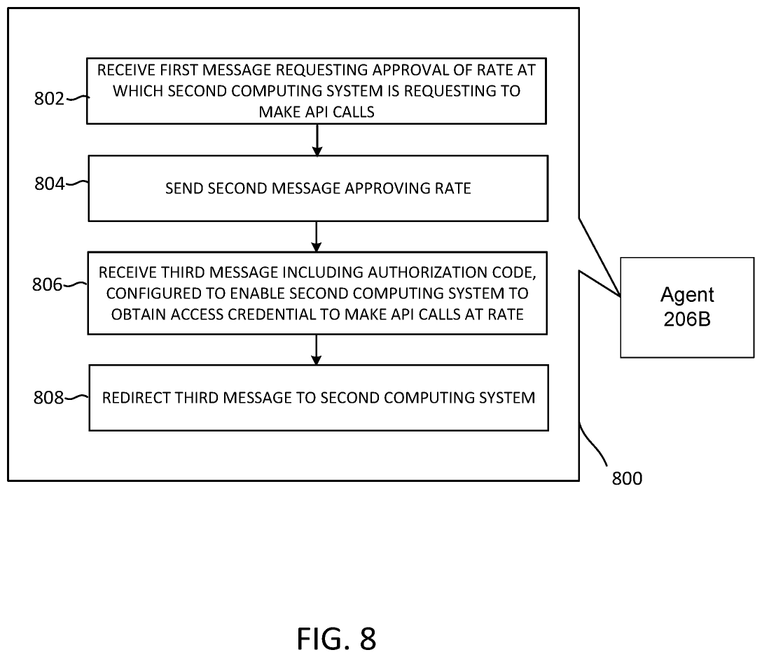

Referring now to FIG. 2B and FIG. 8, an API authorization process 800 involving example operations in accordance with some aspects of the present disclosure is shown. In some embodiments, an agent 206B (e.g., a user agent) may receive (802), from a first computing system (e.g., the server(s) 204B), a first message requesting approval (e.g., user approval) of a rate and/or scope at which a second computing system (e.g., the client 202B) is requesting to make API calls. The user agent 206B may generate and display a consent screen (via, e.g., a web browser) through which a user may approve or deny the requested rate and/or scope. For example, the user may indicate through the consent screen approval of the requested rate and/or scope. In response to the user indicating approval of the requested rate and/or scope, the user agent may send (804) a second message approving the rate requested to the server(s) 204B.

The server(s) 204B) may send, and the agent 206B may receive (806) from the server(s) 204B, a third message including an authorization code. The authorization code may be configured to enable the client 202B to obtain, from the server(s) 204B, an access credential (e.g., a token) to make API calls at the requested rate and/or scope. Further, the user agent 206B may redirect (808) the third message to the client 202B. As described above, the client 202B may use the authorization code (e.g., from the third message) to obtain the access credential (e.g., the token) to make API calls at the requested rate and/or scope.

In some embodiments, the requested scope for which the rate will be applied to API calls requested by the client may be based on the token that is issued. For example, the issued token may enable certain capabilities, such as a number of times the issued token may be used to call the API and/or receive the desired resource from the resource provider 750.

The techniques and features provided in the present disclosure may be implemented as a policy with an API gateway which may be reused across API providers. The API gateway implementation (e.g., via one or more server(s)) may require little if any modification for API authorization as well as rate and/or scope negotiation as described herein. Typically, in order to implement a policy over multiple services (e.g., API services) for a resource provider, the policy may need to be implemented individually for each service. Using the techniques and features described in the present disclosure, the policy may be implemented over multiple services of the resource provider by implementing the policy through an API gateway that may provide an added layer of control or security in front of the resource provider. In this way, the processes for rate negotiation described herein may be implemented and applied to multiple API services provided by the resource provider through the API gateway without having to implement the processes on a service by service basis. In other words, the rate and/or scope negotiation process may be provided as a stand-alone service to the resource provider via the API gateway.

Thus, the API gateway may implement API authorization and/or rate/scope negotiation policies in front of API server(s). Such a capability may benefit API gateway vendors who may implement API authorization and/or rate/scope negotiation in a generic and configurable manner.

While examples have been provided in the present disclosure to illustrate how the advantages of the techniques and features provided may be realized, these examples have been provided for illustrative purposes only and are not intended to limit the scope of the claims below.

F. Example Implementations of Methods, Systems, and Computer-Readable Media in Accordance with the Present Disclosure

The following paragraphs (M1) through (M14) describe examples of methods that may be implemented in accordance with the present disclosure.

(M1) A method may be performed that involves receiving, by a first computing system, a first message indicative of a rate at which a second computing system is requesting to make application programming interface (API) calls; based at least in part on the first message, configuring the first computing system to enable the second computing system to use an access credential to make API calls at the rate; and sending, from the first computing system to the second computing system, the access credential.

(M2) A method may be performed as described in paragraph (M1), wherein the first computing system receives the first message from an agent that received the first message from the second computing system and redirected the first message to the first computing system, and may further involve, after receiving the first message, sending, from the first computing system to the agent, a second message requesting approval of the rate; and receiving, by the first computing system and from the agent, a third message indicating approval of the rate.

(M3) A method may be performed as described in paragraph (M1) or paragraph (M2), wherein the agent comprises a browser executing on a client device.

(M4) A method may be performed as described any of paragraphs (M1) through (M3), and may further involve sending, by the first computing system to the agent, a fourth message and an instruction for the agent to redirect the fourth message to the second computing system, the fourth message including an authorization code enabling the second computing system to obtain the access credential from the first computing system.

(M5) A method may be performed as described any of paragraphs (M1) through (M4), and may further involve sending, by the first computing system to an agent, a second message and an instruction for the agent to redirect the second message to the second computing system, the second message including an authorization code enabling the second computing system to obtain the access credential from the first computing system.

(M6) A method may be performed as described any of paragraphs (M1) through (M5), wherein the first message is further indicative of a unit of time for a denominator of the rate.

(M7) A method may be performed as described any of paragraphs (M1) through (M6), wherein the first message is further indicative of a scope applied to the rate at which the second computing system requests API calls.

(M8) A method may be performed as described any of paragraphs (M1) through (M7), and may further involve receiving, by the first computing system and from the second computing system, an API call with the access credential; determining, by the first computing system, that the second computing system has not exceeded the rate; and based at least in part on determining that the second computing system has not exceeded the rate, processing, by the first computing system, the API call.

(M9) A method may be performed as described any of paragraphs (M1) through (M8), and may further involve receiving, by the first computing system and from the second computing system, an API call with the access credential; determining, by the first computing system, that the second computing system has exceeded the rate; and based at least in part on determining that the second computing system has exceeded the rate, declining, by the first computing system, to process the API call.

(M10) A method may be performed as described any of paragraphs (M1) through (M9), wherein the first message is received from the second computing system, and may further involve authenticating, by the first computing system, an identity of the second computing system; and determining to configure the first computing system to enable the second computing system to use the access credential based at least in part on authentication of the identity of the second computing system.

(M11) A method may be performed as described any of paragraphs (M1) through (M10), and may further involve determining, by the first computing system, to enable the second computing system to use the access credential to make API calls at the rate based at least in part on at least one operational metric of the first computing system.

(M12) A method may be performed as described any of paragraphs (M1) through (M11), wherein the at least one operational metric is based at least in part on at least one of: a processing capacity of the first computing system, a memory of the first computing system, a bandwidth of the first computing system, historical data indicating a number of API calls handled by the first computing system, a projection for a number of API calls to be handled by the first computing system, or a subscription tier of the second computing system.

(M13) A method may be performed that involves receiving, by an agent and from a first computing system, a first message requesting approval of a rate at which a second computing system is requesting to make application programming interface (API) calls; sending, from the agent to the first computing system, a second message approving the rate; receiving, by the agent and from the first computing system, a third message including an authorization code, the authorization code configured to enable the second computing system to obtain, from the first computing system, an access credential to make API calls at the rate; and redirecting, by the agent, the third message to the second computing system.

(M14) A method may be performed as described in paragraph (M13), wherein the agent comprises a browser executing on a client device.

The following paragraphs (S1) through (S14) describe examples of systems and devices that may be implemented in accordance with the present disclosure.

(S1) A first system may comprise at least one processor and at least one computer-readable medium encoded with instructions which, when executed by the at least one processor, cause the first system to receive a first message indicative of a rate at which a second system is requesting to make application programming interface (API) calls; based at least in part on the first message, configure the first system to enable the second system to use an access credential to make API calls at the rate; and send, to the second system, the access credential.

(S2) A first system may be configured as described in paragraph (S1), wherein the first system receives the first message from an agent that received the first message from the second system and redirected the first message to the first system, and the at least one computer-readable medium may be encoded with additional instructions which, when executed by the at least one processor, further cause the first system to after receiving the first message, send, to the agent, a second message requesting approval of the rate; and receive, from the agent, a third message indicating approval of the rate.

(S3) A first system may be configured as described in paragraph (S1) or paragraph (S2), wherein the agent comprises a browser executing on a client device.

(S4) A first system may be configured as described in any of paragraph (S1) through (S3), wherein the at least one computer-readable medium may be encoded with additional instructions which, when executed by the at least one processor, further cause the first system to send, to the agent, a fourth message and an instruction for the agent to redirect the fourth message to the second system, the fourth message including an authorization code enabling the second system to obtain the access credential from the first system.

(S5) A first system may be configured as described in any of paragraph (S1) through (S4), wherein the at least one computer-readable medium may be encoded with additional instructions which, when executed by the at least one processor, further cause the first system to send, to an agent, a second message and an instruction for the agent to redirect the second message to the second system, the second message including an authorization code enabling the second system to obtain the access credential from the first system.

(S6) A first system may be configured as described in any of paragraph (S1) through (S5), wherein the first message is further indicative of a unit of time for a denominator of the rate.

(S7) A first system may be configured as described in any of paragraph (S1) through (S6), wherein the first message is further indicative of a scope applied to the rate at which the second computing system requests API calls.

(S8) A first system may be configured as described in any of paragraph (S1) through (S7), wherein the at least one computer-readable medium may be encoded with additional instructions which, when executed by the at least one processor, further cause the first system to receive, from the second system, an API call with the access credential; determine that the second system has not exceeded the rate; and based at least in part on determining that the second system has not exceeded the rate, process the API call.

(S9) A first system may be configured as described in any of paragraph (S1) through (S8), wherein the at least one computer-readable medium may be encoded with additional instructions which, when executed by the at least one processor, further cause the first system to receive, from the second computing system, an API call with the access credential; determine that the second system has exceeded the rate; and based at least in part on determining that the second system has exceeded the rate, decline to process the API call.

(S10) A first system may be configured as described in any of paragraph (S1) through (S9), wherein the at least one computer-readable medium may be encoded with additional instructions which, when executed by the at least one processor, further cause the first system to authenticate an identity of the second system; and determine to configure the first system to enable the second system to use the access credential based at least in part on authentication of the identity of the second system.

(S11) A first system may be configured as described in any of paragraph (S1) through (S10), wherein the at least one computer-readable medium may be encoded with additional instructions which, when executed by the at least one processor, further cause the first system to determine, by the first system, to enable the second system to use the access credential to make API calls at the rate based at least in part on at least one operational metric of the first system.

(S12) A first system may be configured as described in any of paragraph (S1) through (S11), wherein the at least one operational metric is based at least in part on at least one of: a processing capacity of the first system, a memory of the first system, a bandwidth of the first system, historical data indicating a number of API calls handled by the first system, a projection for a number of API calls to be handled by the first system, or a subscription tier of the second system.

(S13) A system may comprise at least one processor and at least one computer-readable medium encoded with instructions which, when executed by the at least one processor, cause the system to receive, from a first system, a first message requesting approval of a rate at which a second system is requesting to make application programming interface (API) calls; send, to the first system, a second message approving the rate; receive, from the first system, a third message including an authorization code, the authorization code configured to enable the second system to obtain, from the first system, an access credential to make API calls at the rate; and redirect the third message to the second system.

(S14) A system may be configured as described in paragraph (S13), wherein the wherein the system comprises an agent, and the agent comprises a browser.

The following paragraphs (CRM1) through (CRM14) describe examples of computer-readable media that may be implemented in accordance with the present disclosure.

(CRM1) At least one non-transitory, computer-readable medium may be encoded with instructions which, when executed by at least one processor included in a first computing system, cause the first computing system to receive a first message indicative of a rate at which a second computing system is requesting to make application programming interface (API) calls; based at least in part on the first message, configure the first computing system to enable the second computing system to use an access credential to make API calls at the rate; and send, to the second computing system, the access credential.

(CRM2) At least one non-transitory, computer-readable medium may be configured as described in paragraph (CRM1), wherein the first computing system receives the first message from an agent that received the first message from the second computing system and redirected the first message to the first computing system, and may be encoded with additional instructions which, when executed by the at least one processor, further cause the first computing system to after receiving the first message, send, to the agent, a second message requesting approval of the rate; and receive, from the agent, a third message indicating approval of the rate.

(CRM3) At least one non-transitory, computer-readable medium may be configured as described in paragraph (CRM1) or paragraph (CRM2), wherein the agent comprises a browser executing on a client device.

(CRM4) At least one non-transitory, computer-readable medium may be configured as described in any of paragraphs (CRM1) through (CRM3), and may be encoded with additional instructions which, when executed by the at least one processor, further cause the first computing system to send, to the agent, a fourth message and an instruction for the agent to redirect the fourth message to the second computing system, the fourth message including an authorization code enabling the second computing system to obtain the access credential from the first computing system.

(CRM5) At least one non-transitory, computer-readable medium may be configured as described in any of paragraphs (CRM1) through (CRM4), and may be encoded with additional instructions which, when executed by the at least one processor, further cause the first computing system to send, to an agent, a second message and an instruction for the agent to redirect the second message to the second computing system, the second message including an authorization code enabling the second computing system to obtain the access credential from the first computing system.

(CRM6) At least one non-transitory, computer-readable medium may be configured as described in any of paragraphs (CRM1) through (CRM5), wherein the first message is further indicative of a unit of time for a denominator of the rate.

(CRM7) At least one non-transitory, computer-readable medium may be configured as described in any of paragraphs (CRM1) through (CRM6), wherein the first message is further indicative of a scope applied to the rate at which the second computing system requests API calls.

(CRM8) At least one non-transitory, computer-readable medium may be configured as described in any of paragraphs (CRM1) through (CRM7), and may be encoded with additional instructions which, when executed by the at least one processor, further cause the first computing system to receive, from the second computing system, an API call with the access credential; determine that the second computing system has not exceeded the rate; and based at least in part on determining that the second computing system has not exceeded the rate, process the API call.

(CRM9) At least one non-transitory, computer-readable medium may be configured as described in any of paragraphs (CRM1) through (CRM8), and may be encoded with additional instructions which, when executed by the at least one processor, further cause the first computing system to receive, from the second computing system, an API call with the access credential; determine that the second computing system has exceeded the rate; and based at least in part on determining that the second computing system has exceeded the rate, decline to process the API call.

(CRM10) At least one non-transitory, computer-readable medium may be configured as described in any of paragraphs (CRM1) through (CRM9), and may be encoded with additional instructions which, when executed by the at least one processor, further cause the first computing system to authenticate an identity of the second computing system; and determine to configure the first computing system to enable the second computing system to use the access credential based at least in part on authentication of the identity of the second computing system.

(CRM11) At least one non-transitory, computer-readable medium may be configured as described in any of paragraphs (CRM1) through (CRM10), and may be encoded with additional instructions which, when executed by the at least one processor, further cause the first computing system to determine, by the first computing system, to enable the second computing system to use the access credential to make API calls at the rate based at least in part on at least one operational metric of the first computing system.

(CRM12) At least one non-transitory, computer-readable medium may be configured as described in any of paragraphs (CRM1) through (CRM11), wherein the at least one operational metric is based at least in part on at least one of: a processing capacity of the first computing system, a memory of the first computing system, a bandwidth of the first computing system, historical data indicating a number of API calls handled by the first computing system, a projection for a number of API calls to be handled by the first computing system, or a subscription tier of the second computing system.

(CRM13) At least one non-transitory, computer-readable medium may be encoded with instructions which, when executed by at least one processor included in a computing system, cause the computing system to receive, from a first computing system, a first message requesting approval of a rate at which a second computing system is requesting to make application programming interface (API) calls; send, to the first computing system, a second message approving the rate; receive, from the first computing system, a third message including an authorization code, the authorization code configured to enable the second computing system to obtain, from the first computing system, an access credential to make API calls at the rate; and redirect the third message to the second computing system.

(CRM14) At least one non-transitory, computer-readable medium may be configured as described in paragraph (CRM13), the wherein the computing system comprises an agent, and the agent comprises a browser.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a first computing system, a first message indicative of a rate at which a second computing system is requesting to make application programming interface (API) calls;
based at least in part on the first message, configuring the first computing system to enable the second computing system to use an access credential to make API calls at the rate; and
sending, from the first computing system to the second computing system, the access credential.

2. The method of claim 1, wherein the first computing system receives the first message from an agent that received the first message from the second computing system and redirected the first message to the first computing system, and the method further comprises:
after receiving the first message, sending, from the first computing system to the agent, a second message requesting approval of the rate; and
receiving, by the first computing system and from the agent, a third message indicating approval of the rate.

3. The method of claim 2, wherein the agent comprises a browser executing on a client device.

4. The method of claim 2, further comprising:
sending, by the first computing system to the agent, a fourth message and an instruction for the agent to redirect the fourth message to the second computing system, the fourth message including an authorization code enabling the second computing system to obtain the access credential from the first computing system.

5. The method of claim 1, further comprising:
sending, by the first computing system to an agent, a second message and an instruction for the agent to redirect the second message to the second computing system, the second message including an authorization code enabling the second computing system to obtain the access credential from the first computing system.

6. The method of claim 1, wherein the first message is further indicative of a unit of time for a denominator of the rate.

7. The method of claim 1, wherein the first message is further indicative of a scope applied to the rate at which the second computing system requests API calls.

8. The method of claim 1, further comprising:
receiving, by the first computing system and from the second computing system, an API call with the access credential;
determining, by the first computing system, that the second computing system has not exceeded the rate; and
based at least in part on determining that the second computing system has not exceeded the rate, processing, by the first computing system, the API call.

9. The method of claim 1, further comprising:
receiving, by the first computing system and from the second computing system, an API call with the access credential;
determining, by the first computing system, that the second computing system has exceeded the rate; and
based at least in part on determining that the second computing system has exceeded the rate, declining, by the first computing system, to process the API call.

10. The method of claim 1, wherein the first message is received from the second computing system, and the method further comprises:
authenticating, by the first computing system, an identity of the second computing system; and
determining to configure the first computing system to enable the second computing system to use the access credential based at least in part on authentication of the identity of the second computing system.

11. The method of claim 1, further comprising:
determining, by the first computing system, to enable the second computing system to use the access credential to make API calls at the rate based at least in part on at least one operational metric of the first computing system.

12. The method of claim 1, wherein the at least one operational metric is based at least in part on at least one of: a processing capacity of the first computing system, a memory of the first computing system, a bandwidth of the first computing system, historical data indicating a number of API calls handled by the first computing system, a projection for a number of API calls to be handled by the first computing system, or a subscription tier of the second computing system.

13. A first system, comprising:
at least one processor; and
at least one computer-readable medium encoded with instructions which, when executed by the at least one processor, cause the first system to:
receive a first message indicative of a rate at which a second system is requesting to make application programming interface (API) calls;
based at least in part on the first message, configure the first system to enable the second system to use an access credential to make API calls at the rate; and
send, to the second system, the access credential.

14. The first system of claim 13, wherein the first system receives the first message from an agent that received the first message from the second system and redirected the first message to the first system, and the at least one computer-readable medium is further encoded with additional instructions which, when executed by the at least one processor, further cause the first system to:
after receiving the first message, send, to the agent, a second message requesting approval of the rate; and
receive, from the agent, a third message indicating approval of the rate.

15. The first system of claim 14, wherein the agent comprises a browser executing on a client device.

16. The first system of claim 14, wherein the at least one computer-readable medium is further encoded with additional instructions which, when executed by the at least one processor, further cause the first system to:
send, to the agent, a fourth message and an instruction for the agent to redirect the fourth message to the second system, the fourth message including an authorization code enabling the second system to obtain the access credential from the first system.

17. The first system of claim 13, wherein the at least one computer-readable medium is further encoded with additional instructions which, when executed by the at least one processor, further cause the first system to:
send, to an agent, a second message and an instruction for the agent to redirect the second message to the second system, the second message including an authorization code enabling the second system to obtain the access credential from the first system.

18. The first system of claim 13, wherein the first message is further indicative of a unit of time for a denominator of the rate.

19. A method, comprising:
receiving, by an agent and from a first computing system, a first message requesting approval of a rate at which a second computing system is requesting to make application programming interface (API) calls;
sending, from the agent to the first computing system, a second message approving the rate;
receiving, by the agent and from the first computing system, a third message including an authorization code, the authorization code configured to enable the second computing system to obtain, from the first computing system, an access credential to make API calls at the rate; and
redirecting, by the agent, the third message to the second computing system.

20. The method of claim 19, wherein the agent comprises a browser executing on a client device.
